(19) United States
(12) Patent Application Publication
(10) Pub. No.: US 2026/0136022 A1
(43) Pub. Date: May 14, 2026

(54) PROBABILITY MODEL INITIALIZATION BASED ON CANDIDATE PROBABILITY MODEL SELECTION

(71) Applicant: GOOGLE LLC, Mountain View, CA (US)

(72) Inventors: Lin Zheng, Waterloo (CA); Jingning Han, Santa Clara, CA (US); Yaowu Xu, Saratoga, CA (US)

(21) Appl. No.: 19/384,211

(22) Filed: Nov. 10, 2025

Related U.S. Application Data
(60) Provisional application No. 63/719,081, filed on Nov. 11, 2024.

(51) Int. Cl. H04N 19/174; H04N 19/105; H04N 19/70

(52) U.S. Cl. CPC H04N 19/174; H04N 19/105; H04N 19/70

(57) ABSTRACT

Techniques for initializing probability models for tiles of a current frame in a video stream are disclosed. A first identification is decoded from a bitstream, specifying two or more respective tiles in a reference frame. A set of candidate probability models is established in a reference frame buffer by populating the set with probability models obtained from the specified tiles. For a current tile in a current frame, a second identification is decoded from the bitstream, identifying a single candidate probability model within the established set. A probability model for the current tile is then initialized using the single candidate probability model pointed to by the second identification.

### CROSS-REFERENCE TO RELATED APPLICATION(S)

This disclosure claims the benefit of U.S. Provisional Patent Application No. 63/719,081 filed November 11, 2024, the disclosure of which is incorporated by reference herein in its entirety.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including compression and other coding techniques. These techniques may include both lossy and lossless coding techniques.

### SUMMARY

This disclosure relates generally to encoding and decoding video data and more particularly relates to probability model initialization for a tile based on candidate probability model selection.

In an aspect of the disclosure, a method for initializing probability models for tiles of a current frame in a video stream is provided. The method includes decoding a first identification from a bitstream, the first identification specifying two or more respective tiles in a reference frame, establishing a set of candidate probability models for the reference frame in a reference frame buffer by populating the set with probability models obtained from the two or more respective tiles specified by the first identification, and for a current tile of a plurality of current tiles in a current frame, decoding a second identification from the bitstream, the second identification identifying a single candidate probability model within the established set, and initializing a probability model for the current tile using the single candidate probability model pointed to by the second identification.

In another aspect of the disclosure, a device for initializing probability models for tiles of a current frame in a video stream is provided. The device includes a memory and a processor configured to execute instructions stored in the memory to: decode a first identification from a bitstream, the first identification specifying two or more respective tiles in a reference frame, establish a set of candidate probability models for the reference frame in a reference frame buffer by populating the set with probability models obtained from the two or more respective tiles specified by the first identification, and for a current tile of a plurality of current tiles in a current frame, decode a second identification from the bitstream, the second identification identifying a single candidate probability model within the established set, and initialize a probability model for the current tile using the single candidate probability model pointed to by the second identification.

In another aspect of the disclosure, a non-transitory computer-readable storage medium is provided. The non-transitory computer-readable storage medium has stored thereon an encoded video bitstream including a first indication and a second indication, wherein the encoded video bitstream is decodable by a decoder configured to: decode a first identification from the encoded video bitstream, the first identification specifying two or more respective tiles in a reference frame, establish a set of candidate probability models for the reference frame in a reference frame buffer by populating the set with probability models obtained from the two or more respective tiles specified by the first identification, and for a current tile of a plurality of current tiles in a current frame, decode a second identification from the encoded video bitstream, the second identification identifying a single candidate probability model within the established set, and initialize a probability model for the current tile using the single candidate probability model pointed to by the second identification.

These and other aspects of the present disclosure are disclosed in the following detailed description of the embodiments, the appended claims, and the accompanying figures.

### BRIEF DESCRIPTION OF THE DRAWINGS

The description herein refers to the accompanying drawings described below wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of an example of a video stream to be encoded and subsequently decoded.

FIG. 4 is a block diagram of an encoder.

FIG. 5 is a block diagram of a decoder.

FIG. 6 is a flowchart describing techniques for probability initialization.

FIG. 7 is a block diagram illustrating a first storage configuration for caching and saving probability models and an associated data flow.

FIG. 8 is a block diagram illustrating a second storage configuration for saving candidate probability models.

FIG. 9 is a flowchart describing a first technique for probability model initialization for a tile based on candidate probability model selection.

FIG. 10 is a flowchart describing a second technique for probability model initialization for a tile based on candidate probability model selection.

FIG. 11 is a flowchart describing a third technique for probability model initialization for a tile based on candidate probability model selection.

### DETAILED DESCRIPTION

As mentioned above, compression schemes related to coding video streams may include breaking images (i.e., original or source images) into blocks and generating a digital video output bitstream using one or more techniques to limit the information included in the output. A received encoded bitstream can be decoded to re-create the blocks and the source images from the limited information. A video stream may be encoded using a variety of tools resulting in a variety of syntax elements which are stored in a compressed bitstream to enable the transfer of the encoded information between an encoder and a decoder. These syntax elements may be encoded in the compressed bitstream using lossless encoding.

One type of lossless coding is called entropy coding. Entropy is generally considered the degree of disorder or randomness in a system. Entropy coding is designed to compress a sequence (e.g., including bits representing a syntax element) in an informationally efficient way. A lower bound of the length of the compressed sequence is the entropy of the original sequence. An efficient algorithm for entropy coding aims to generate a code (e.g., in bits) whose length approaches this entropy. For a particular sequence of syntax elements, the entropy associated with the code may be measured as a function of the probability distribution(s) of observations (e.g., symbols, values, outcomes, hypotheses, etc.) for the syntax elements over the sequence. In some implementations, separate probability distributions may be measured for different syntax elements in order to obtain a more compact set of probability distributions. Arithmetic coding, for example, can use a measured probability distribution to construct a code used to encode the sequence.

A codec may not receive a sequence together with its actual probability distribution(s). Instead, probability estimation may be used in video codecs to implement entropy coding. The probability distribution(s) in an encoded bitstream (e.g., for a frame or a tile in the encoded bitstream) may be estimated using one or more probability models that model the distribution occurring in an encoded bitstream. A probability model can include multiple sets of probabilities each representing, for example, a probability distribution for a particular syntax element or syntax elements. A probability model can include multiple sets of probabilities for a particular syntax element, where the set of probabilities utilized may depend on a context of previously encoded or decoded information. The probability models are ideally designed so that the estimated probability distribution approaches the actual probability distribution. Using these techniques, entropy coding can reduce the number of bits required to represent the input data to close to a theoretical minimum (i.e., the lower bound). The probability models may be expressed or given by various mathematical functions, including a probability mass function (PMF) or Cumulative Distribution Functions (CDFs).

Generally, a probability model (e.g., including a set of CDFs) is initialized at the start of a frame or tile to be encoded or decoded. The initialization, for example, may be performed using sets of default probabilities (e.g., where no previously computed probability models are available). The initialization may also be performed by utilizing a probability model from a prior frame, such as a largest tile in a prior frame, to initialize the probability model for the current frame (e.g., which may include the probability models used for all tiles within the current frame). As symbols (e.g., corresponding to particular syntax elements) are encountered during encoding or decoding, the initialized probability model is updated according to the actual data encountered during encoding or decoding. For example, after each encoded or decoded symbol, the set of probabilities that applies to the prior symbol may be updated based on the observation of an additional example of a particular symbol (e.g., the probability of the occurrence of that symbol may be increased). This process repeats (using the same procedure at encoder and decoder) until the end of the frame or tile. The resulting probability model (once the frame or tile is encoded/decoded) is likely more accurate than the initialized probability model because of the observations made during encoding/decoding and the updates that were accordingly made to the probability model. Generally speaking, when tiles are utilized, each tile utilizes its own probability model which is updated separately in the course of encoding/decoding each such tile (because tiles, in many cases, may be encoded or decoded independently of each other).

One way of utilizing such a previously updated probability model would be to utilize a single probability model associated with a reference frame to initialize the probability models for the tiles in a current frame. For example, the single probability model may be selected from the largest tile in the reference frame, or may be an average or weighted average of a subset or all of the probability models of the tiles of the reference frame. Problems with this approach include that the initialized probability distribution may be the same for all of the tiles in the current frame whereas the actual probability distribution for various tiles in the current frame may vary. Therefore, the initialized probability distribution may have a greater deviation from the actual probability distribution of a tile than is desired.

Implementations according to this disclosure solve problems such as these by establishing a set of candidate probability models for a reference frame by populating the set with probability models obtained from two or more respective tiles of the reference frame. Then, for each of a plurality of tiles in a current frame, a single model is selected from the established set and used to initialize a probability model for that current tile. The set of candidate probability models may be saved to a reference frame buffer. For example, up to a pre-determined maximum number of probability models corresponding to tiles in the reference frame may be saved in the reference frame buffer in order to permit those probability models to be adaptively utilized when initializing probability models for tiles of the current frame. The selection of these candidate probability models for inclusion in the reference frame buffer may be determined based on a common technique utilized by both encoder or decoder or may be performed by the encoder and identification of the tiles selected (from which the candidate probability models are saved) may be included in the compressed bitstream so that the decoder is able to utilize the same candidate probability models as the encoder.

The disclosed techniques provide technical advantages over systems such as those that initialize a current tile's probability model based on a single, corresponding tile from a reference frame or based on a correspondence in location between a current tile and a corresponding tile from a reference frame. By first creating a set of several high-quality candidate probability models from diverse tiles within a reference frame, the disclosed techniques establish multiple potential initialization states that can be selected from. Subsequently, each tile in the current frame can be associated with the best-fitting model from this library, regardless of spatial co-location. For example, a tile with complex content can be initialized with a model from a similarly complex but non-adjacent tile in the reference frame.

In some implementations, the encoder selects which of the candidate probability models from a reference frame buffer is to be utilized to initialize the probability model for a current tile in a current frame and includes an identification in the compressed bitstream so that the decoder is able to utilize the same candidate probability model for that current tile. For example, the candidate probability models may be stored in an array, the current tile is associated with an identifier in the compressed bitstream that is an integer referring to an entry in the array of candidate probability models, and the decoder obtains the candidate probability model usable for decoding the current tile from the array using the identifier.

In some implementations, the candidate probability models are associated with a particular reference frame. In such implementations, the selection of reference frame to be utilized for a current frame may be determined by an encoder and a reference frame identification may be included in a compressed bitstream so that the decoder is able to select the correct set of candidate probability models to reference in a reference frame buffer.

In some implementations, the number of candidate probability models saved and available for use may be capped at a maximum number of candidate probability models, which may be for example, 2 or 4 candidate probability models.

As used herein, a 'tile' refers to a spatially distinct, independently decodable region of a video frame, such as a rectangular group of blocks. A 'probability model' refers to a set of probability distributions (e.g., CDFs or PMFs) for various syntax elements used in entropy coding. A tile in a current frame is considered 'co-located' with a tile in a reference frame if it occupies the same or substantially the same spatial position within the frame boundaries.

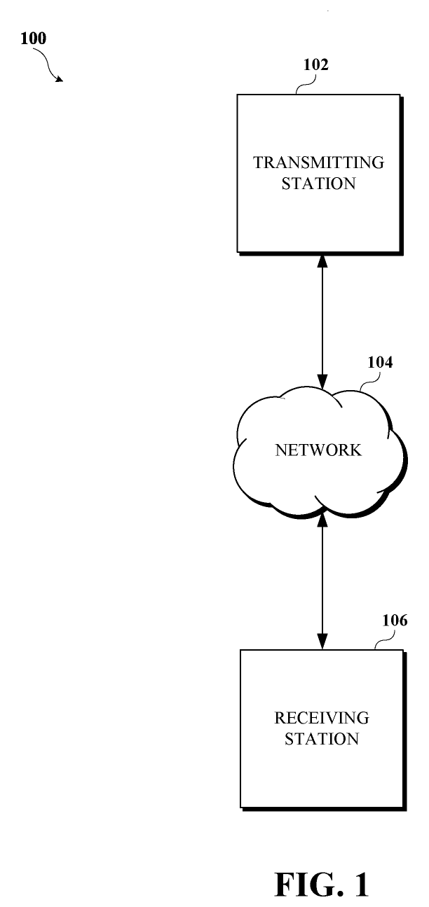

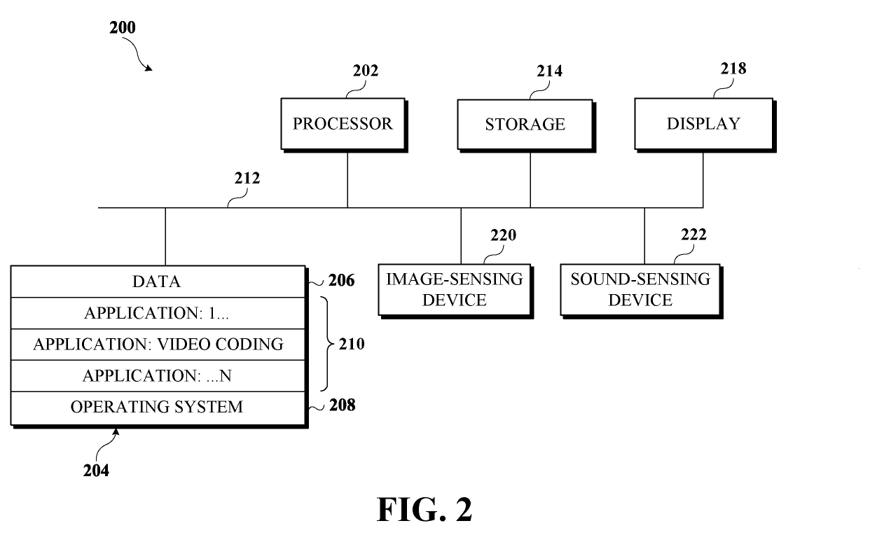

Further details of probability model initialization for a tile based on candidate probability model selection are described herein with initial reference to a system in which it can be implemented. FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102 and the encoded video stream can be decoded in the receiving station 106. The network 104 can be, for example, the Internet. The network 104 can also be a local area network (LAN), wide area network (WAN), virtual private network (VPN), cellular telephone network or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a Hypertext Transfer Protocol (HTTP) video streaming protocol.

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits its own video bitstream to the video conference server for decoding and viewing by other participants.

FIG. 2 is a block diagram of an example of a computing device 200 (e.g., an apparatus) that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A CPU 202 in the computing device 200 can be a conventional central processing unit. Alternatively, the CPU 202 can be any other type of device, or multiple devices, capable of manipulating or processing information now existing or hereafter developed. Although the disclosed implementations can be practiced with one processor as shown, e.g., the CPU 202, advantages in speed and efficiency can be achieved using more than one processor.

A memory 204 in computing device 200 can be a read only memory (ROM) device or a random-access memory (RAM) device in an implementation. Any other suitable type of storage device can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the techniques described here. For example, the application programs 210 can include applications 1 through N, which further include a video coding application that performs the techniques described here. Computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display or light emitting diode (LED) display, such as an organic LED (OLED) display.

The computing device 200 can also include or be in communication with an image-sensing device 220, for example a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into one unit, other configurations can be utilized. The operations of the CPU 202 can be distributed across multiple machines (wherein individual machines can have one or more of processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

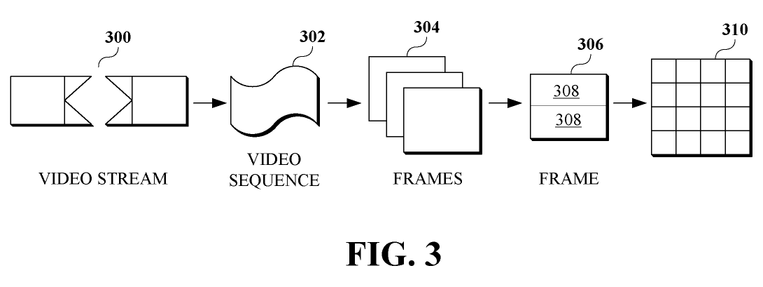

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, e.g., a frame 306. At the next level, the frame 306 can be divided into a series of planes or segments 308. The segments 308 (e.g., which may also be referred to as tiles) can be subsets of frames that permit parallel processing, for example. The configuration of tiles in a frame may vary depending on the implementation, and may take the form of columns, rows, rectangular areas, or other collections of blocks, depending on the implementation. The use of tiles may be configured such that encoding a tile does not have dependencies on or has limited dependencies on other tiles to permit tiles to be decoded independently of each other. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16x16 pixels in the frame 306. The blocks 310 can also be arranged to include data from one or more segments 308 of pixel data. The blocks 310 can also be of any other suitable size such as 4x4 pixels, 8x8 pixels, 16x8 pixels, 8x16 pixels, 16x16 pixels, or larger. Unless otherwise noted, the terms block and macro-block are used interchangeably herein.

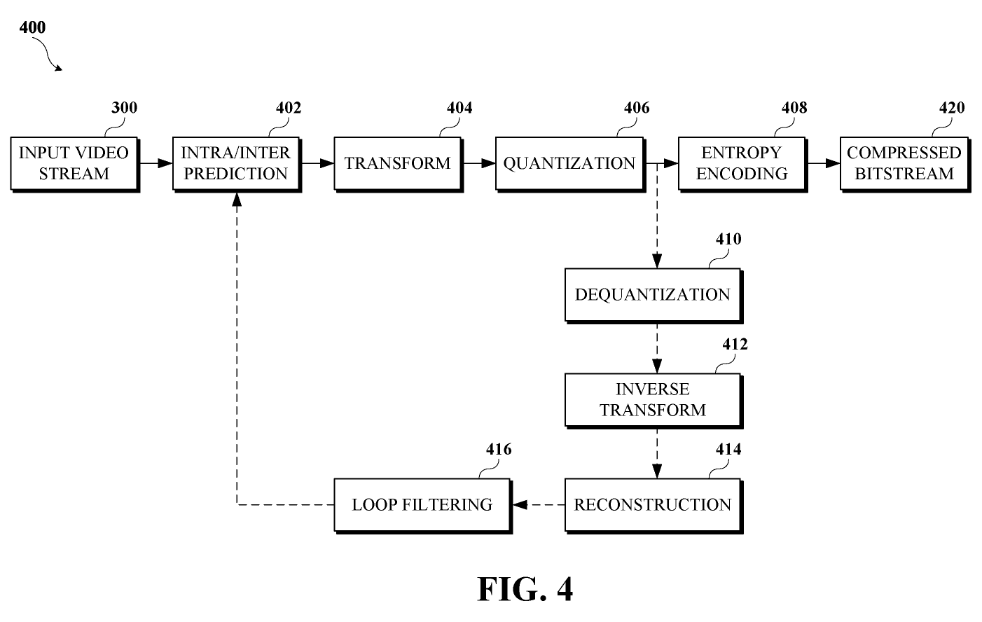

FIG. 4 is a block diagram of an encoder 400. The encoder 400 can be implemented, as described above, in the transmitting station 102 such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block, which may include for example the type of prediction used, transform type, MVs and quantizer value, are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs functions that are similar to functions that take place during the decoding process that are discussed in more detail below, including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform-based encoder can quantize the residual signal directly without the transform stage 404 for certain blocks or frames. In another implementation, an encoder can have the quantization stage 406 and the dequantization stage 410 combined in a common stage.

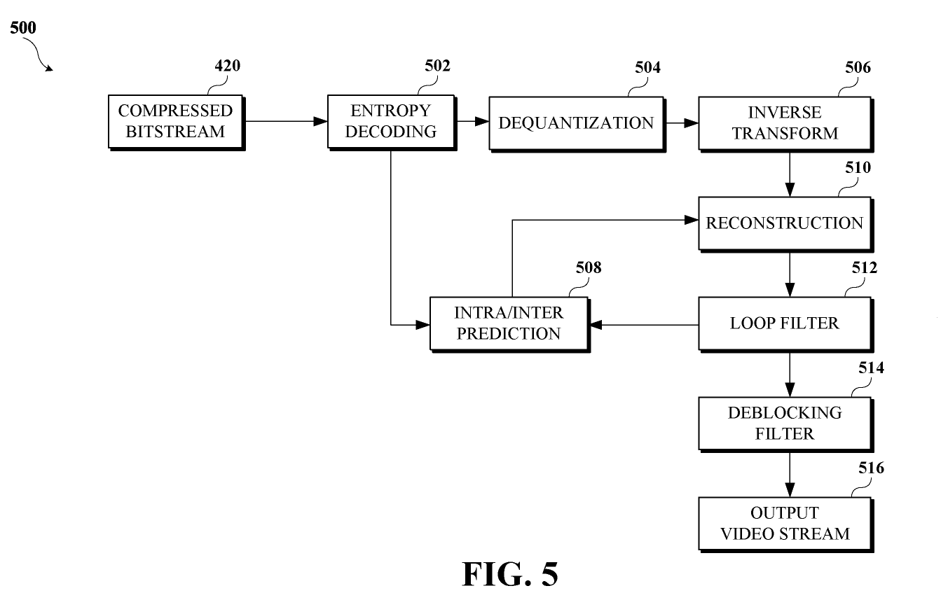

FIG. 5 is a block diagram of a decoder 500. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512 and a post-loop filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients and other decoded syntax elements needed for the decoding process. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts.

As can be appreciated from the description of the encoder 400 and the decoder 500 above, bits are generally used for content prediction (e.g., inter mode/motion vector coding, intra prediction mode coding, etc.), residual or coefficient coding (e.g., transform coefficients), or other side information needed to decode the compressed bitstream. Encoders may use techniques to decrease the bits spent on representing this data. For example, a coefficient token tree (which may also be referred to as a binary token tree) may specify the scope of the value, with forward-adaptive probabilities for each branch in this token tree. The token base value is subtracted from the value to be coded to form a residual, then the block is coded using the probabilities applicable for that residual. A similar scheme with minor variations including backward-adaptivity is also possible. Adaptive techniques can alter the probability models as the video stream is being encoded to adapt to changing characteristics of the data. In any event, a decoder is informed of (or has available) the probability model used to encode an entropy-coded video bitstream so the decoder can decode the video bitstream.

That is, and as described initially above, a video codec may use arithmetic coding to effectuate the entropy coding of syntax elements (such as the data referenced above). The coding efficiency is dependent on the accuracy of the probability model used for the tiles and/or frames in the video bitstream. The probability model may be, for example, represented by a PMF or a CDF for each or groups of the various syntax elements in the bitstream. Additional PMFs or CDFs may be provided for a given syntax element(s) which may be selected depending on context. For example, a probability model may include a large number of CDFs each representative of the current probability distribution for a given syntax element / context combination.

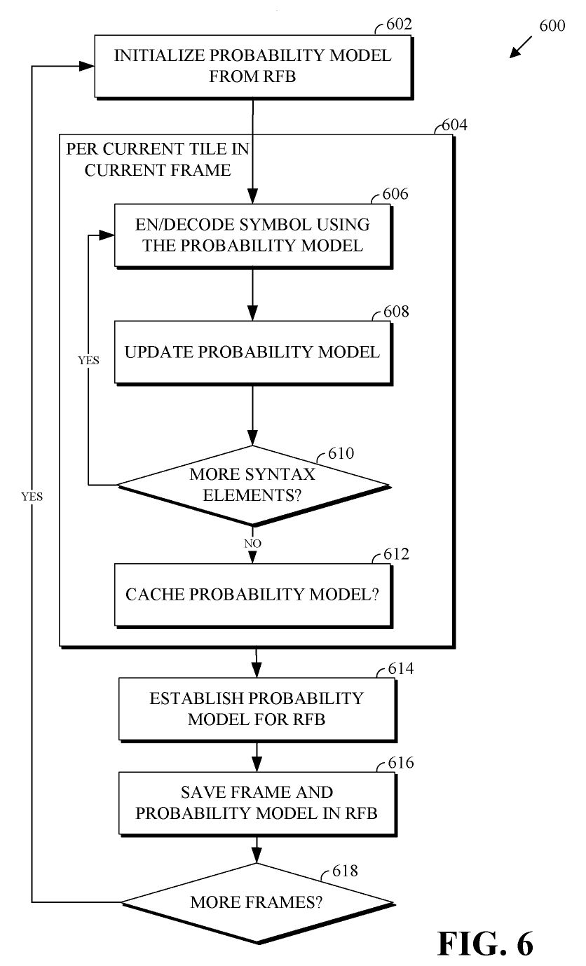

FIG. 6 is a flowchart describing techniques 600 for probability initialization. Techniques 600 may be performed by an encoder or decoder, such as encoder 400 using entropy encoding stage 408 or decoder 500 using entropy decoding stage 502.

At step 602, a probability model for a current frame is initialized from a probability model stored in a reference frame buffer (RFB). For example, a reference frame buffer may include storage for information about multiple reference frames (e.g., four or seven), and for each such reference frame, the decoded reference frame and a probability model for the reference frame may be stored. A syntax element may be included in a compressed bitstream identifying which reference frame to utilize for a current frame (e.g., in the case of a decoder) or the reference frame to utilize for a current frame may be determined (e.g., in the case of an encoder). The saved probability model corresponding to the identified or determined reference frame can be used to initialize the probability model for the current frame. In certain implementations, the same initialized probability model is used for all tiles in the current frame. That is, a single probability model may be used that serves as a global initial state for the current frame, and is used to initialize the respective probability model used for each of the tiles in the current frame before they are individually processed. In some implementations, a probability model may be selected from the set of candidate probability models on a tile-by-tile basis such that different probability models may be used to initialize different tiles in a current frame. In such an implementation an indication may be encoded per tile to indicate which of the set of candidate probability models should be utilized to initialize the probability model for each respective tile.

At step 604, current tiles in the current frame are encoded or decoded (e.g., depending on whether techniques 600 are performed by an encoder or decoder) using steps 606-612. The group of steps 606-612 may be performed for each current tile concurrently, in parallel, or some combination thereof, depending on the implementation.

At step 606, a symbol is encoded or decoded using the probability model for the tile. The symbol is a value corresponding to a syntax element in a compressed bitstream. If no prior syntax elements have been encoded or decoded, the probability model is the same as the initialized probability model from step 602. If prior syntax elements have been encoded or decoded the probability model has been updated (perhaps many times) by step 608 and has changed according to the actual occurrences of symbols encoded or decoded for the current tile. For example, a syntax element may represent an x component of a motion vector and the symbol may indicate the value of the x component.

At step 608, the probability model is updated based on the occurrence of the symbol encoded or decoded at step 606. For example, a count of the symbol for the associated syntax element may be incremented and a set of probabilities for that syntax may be updated based on the updated count.

At step 610, if there are more syntax elements to be encoded or decoded for the current tile, control passes back to step 606 to encode or decode the next syntax element. If all syntax elements have been encoded or decoded, control passes to step 612.

At step 612, a determination is made as to whether to cache the probability model for the current tile. In some implementations, the determination is made by a technique common to both the encoder and decoder. For example, if a maximum of four probability models may be cached, the probability models from the four largest tiles may be cached or the four probability models having the largest number of probability updates may be cached. In another example, probability models may be cached based on tile location.

In some implementations, probability models may be cached along with an indication of the tile from which the probability model was cached or information needed to determine whether a probability model from a later encoded or decoded tile should be cached instead of the previously cached probability model. For example, the probability models for the first four tiles encoded or decoded for a current frame may be cached along with an indication of the size of those tiles. When step 612 is reached for the following encoded or decoded tiles, the size of those tiles may be compared to the size of the tiles from which the previously cached probability models were obtained. If the later tile is larger in size than the prior tiles from which the cached probability models were obtained, the probability model from the later tile may be cached instead of the previously cached probability model associated with the smallest tile. This process of comparing a later tile to a previously cached tile and replacing a model in the cache based on a size comparison is one example of a dynamic process for establishing the set of candidate probability models.

Control passes to step 614 once step 604 is completed (e.g., all tiles have completed steps 606-612). At step 614, the final set of candidate probability models is established from the cached probability models. For example, the models cached based on the criteria in step 612 (e.g., largest size, first N tiles) are determined to be saved to the reference frame buffer as the established set of candidate probability models. In some implementations, a single probability model or a set of probability models including one or more generated probability models may be established. For example, a generated (or combined) probability model may be generated, for example, by averaging or weighted averaging some or all of the cached probability model.

At step 616, the current frame and set of candidate probability models is saved into a reference frame buffer. For example, if the reference frame buffer has room for multiple reference frames, the current frame buffer and combined probability model may be saved in a location identified by a number x, e.g., RFB[x]. In some implementations, the encoder may determine whether or where to store the current frame and set of candidate probability models in the RFB and this determination may be included in the compressed bitstream so that the decoder may do the same. In the case where the reference frame is not stored in the reference frame buffer, steps 614 and 616 may be skipped for a given current frame. In some implementations, steps 614 and 616 may be combined. In some implementations, step 614 may be omitted and establishing the set of candidate probability models may be performed through the caching of probability models in step 612 and the saving of the cached probability models in step 616. In some implementations, step 612 may instead save probability models into the reference frame buffer without utilizing a cache for the set of candidate probability models. In such an implementation, step 614 and/or step 616 may be omitted.

At step 618, if there are more frames, control passes back to step 602 to initialize the probability model for the next frame.

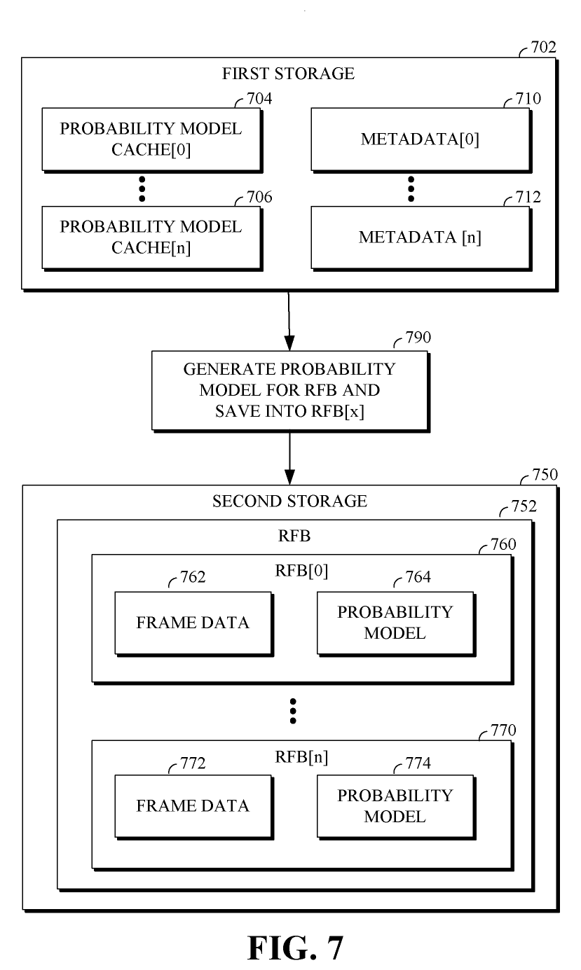

FIG. 7 is a block diagram illustrating a first storage configuration for caching and saving probability models and an associated data flow. FIG. 7 includes a first storage 702 and a second storage 750. First storage 702 may be implemented using a faster storage mechanism, such as SRAM on a hardware encoder or decoder. Second storage 750 may be implemented using a slower storage mechanism, such as DRAM connected to a hardware encoder or decoder.

First storage 702 may include multiple probability model cache storage areas 704, 706 (e.g., n storage areas as depicted) and multiple metadata storage areas 710, 712 (e.g., n storage areas as depicted). Probability model cache storage areas 704, 706 may be utilized to store cached probability models that, e.g., are cached at step 612 of FIG. 6. Metadata storage areas 710, 712 may be utilized to store additional information relating to the cached probability models that may be utilized by the encoder or decoder to determine how to cache probability models (e.g., such as the size of the tile, number of probability updates, or location of the tile from which the associated cached probability model is obtained). For example, the information in metadata[0] may correspond to the probability model in probability model cache[0]. In some implementations, metadata storage areas 710, 712 may be omitted or implemented differently, for example if identifications of the tiles to use for caching probability models are determined by the encoder and transmitted in the compressed bitstream.

Second storage 750 may include a reference frame buffer (RFB) 752 that includes multiple storage areas 760, 770 (e.g., as shown, n storage areas) for storing reference frame data such as frame data 762, 772 and probability model 764, 774. For example, one of the storage areas 760, 770 may be used to store the frame data and combined probability model stored in step 616 of FIG. 6.

Data stored in first storage 702 may be accessed and utilized in order to execute technique 790 of generating probability model for RFB and saving the probability model into RFB[x] (e.g., one of storage areas 760, 770) which is in second storage 750. Technique 790 may, for example, correspond to steps 614 and 616 of FIG. 6. As previously described, generating the probability model (e.g., a combined probability model) may be performed using an average or weighted average of probability models. It is advantageous for the average, weighted average, or other combination of probability models to be performed using the cached probability models stored in first storage 702 because first storage 702 is implemented using memory with a faster access speed, such as SRAM (as compared to, for example, DRAM for second storage 750). By comparison, performing the combination using information stored in DRAM or other slower storage may disadvantageously increase the time required to perform the combination such that the encoding or decoding process will be delayed.

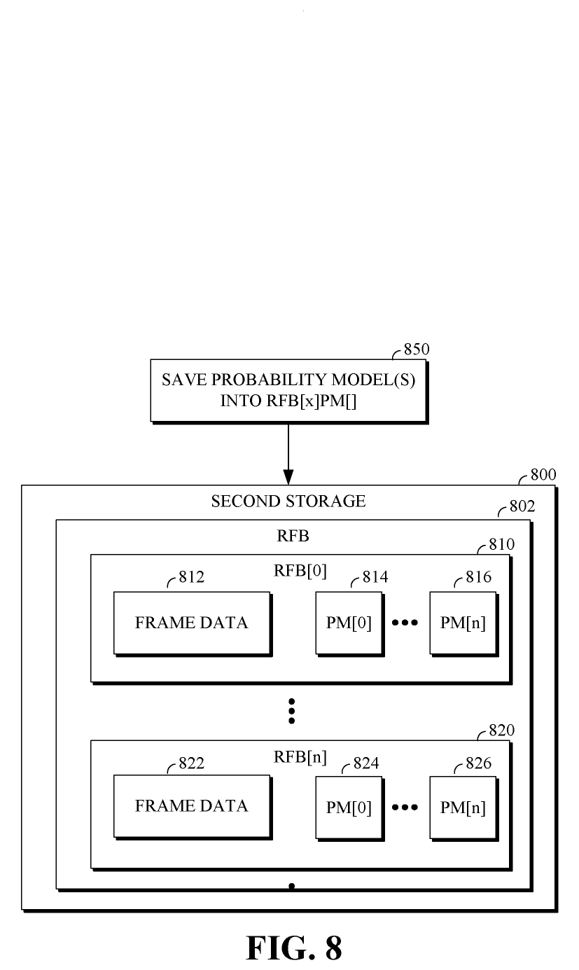

FIG. 8 is a block diagram illustrating a second storage configuration for saving candidate probability models. FIG. 8 includes second storage 800. Second storage 800 may be implemented using a slower storage mechanism than SRAM, such as DRAM connected to a hardware encoder or decoder.

Second storage 800 may include a reference frame buffer (RFB) that includes multiple storage areas 810, 820 (e.g., as shown, n storage areas) for storing reference frame data such as frame data 812, 822 and probability models[] (PM[]) 814, 816, 824, 826. The PM[] as shown for the storage areas 810, 820 are configured to permit the storage of up to n candidate probability models for each storage area in the RFB.

Technique 850 may be utilized to save probability model(s) into one of the storage areas 810, 820 (e.g., identified by x in FIG. 8). For example, in some implementations, with respect to FIG. 6, technique 850 may replace step 612 and steps 614 and 616 may be omitted. In such an implementation, the encoder and/or decoder may determine the tiles from which the set of candidate models will be obtained from. This, for example, may be an encoder determination based on, e.g., a rate distortion analysis, the result of which (e.g., tile indexes from which the candidate probability models are saved) may be included in the compressed bitstream so that during decoding, the decoder may also save the same probability models as candidate models. In other implementations, a predetermined process may be used by both encoder and decoder may to determine the tiles from which the set of candidate models will be obtained from (e.g., based on tile size, distribution of tile locations, counts associated with probability model updates of individual tiles, etc.).

In other implementations, technique 850 may utilize a modification of steps 612, 614, and/or 616 of FIG. 6. For example, step 614 may be configured to generate multiple combined probability models from a reference frame that are separately saved as candidate probability models. For example, certain areas of a reference frame or groups of tiles in the reference frame may separately have probability models cached by step 612, combined by step 614, and saved by step 616 in distinct candidate probability model slots in the PM[] array. In such implementations, second storage 800 may replace second storage 750 as described above with respect to FIG. 7.

In some implementations, a first storage (e.g., like first storage 702) may also be utilized and the candidate probability models may first be cached in the first storage (e.g., which may be implemented in faster storage, such as DRAM). Once the set of candidate probability models is established (e.g., which may include updating or replacing the cached probability models as tiles are encoded or decoded), the set of candidate probability models may then be stored in second storage 800.

Further variations of the above are possible, including hybrid arrangements between the implementations described above.

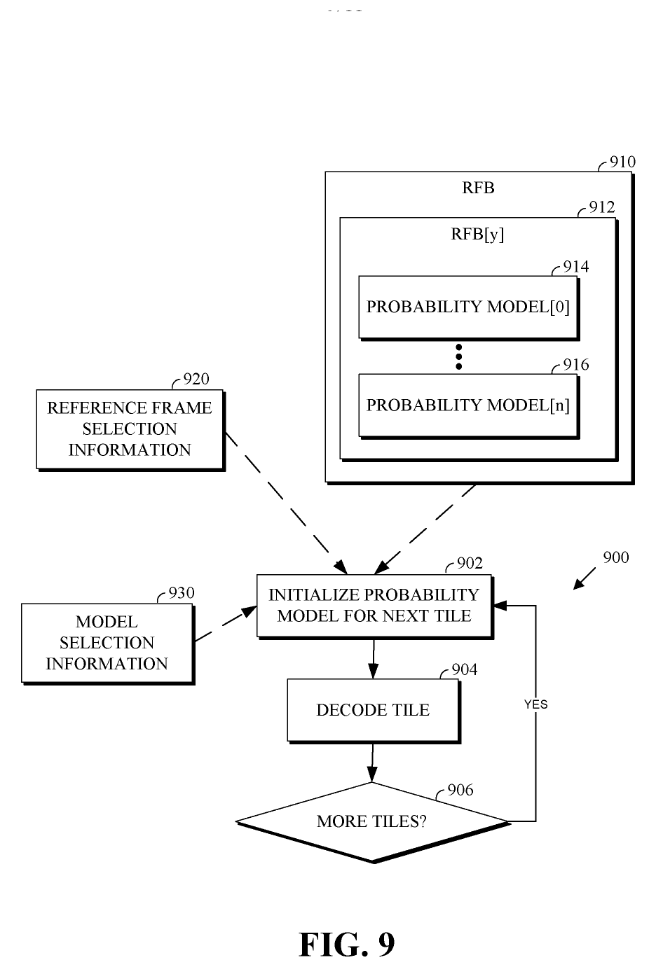

FIG. 9 is a flowchart describing a first technique 900 for probability model initialization for a tile based on candidate probability model selection. Technique 900 may be performed by an encoder or decoder, such as encoder 400 using entropy encoding stage 408 or decoder 500 using entropy decoding stage 502. FIG. 9 illustrates how probability models may be selected from a set of candidate probability models and initialized for decoding on a tile by tile basis, for example, in the context of the techniques and systems described above such as with respect to FIGS. 6 and 8.

At step 902, a probability model is initialized for a next tile in a current frame. Step 902 takes as input reference frame selection information 920 (also referred to as RFS) and model selection information 930 (also referred to as MSI) and utilizes RFB 910 which includes storage areas including storage area 912 and for each storage area a candidate probability model array such as depicted by probability model[0…n] 914, 916. The candidate probability model used to initialize the next tile (which may also be referred to as a current tile) in the current frame is obtained from the RFB using RFS and MSI, such as by using the RFS and MSI as indexes to the RFB data structure: RFB[RFS][MSI]. The probability model for the next tile is initialized using the obtained candidate probability model.

At step 904, the tile is decoded using the initialized probability model. This step and step 902 may be performed in a non-blocking manner. In other words, control may pass to step 906 before steps 902 and/or 904 completes. In some implementations, control may block (e.g., pause) if a maximum number of parallel executions of steps 902 and/or 904 have been reached.

At step 906, if there are more tiles to be encoded or decoded in the current frame, control passes back to step 902.

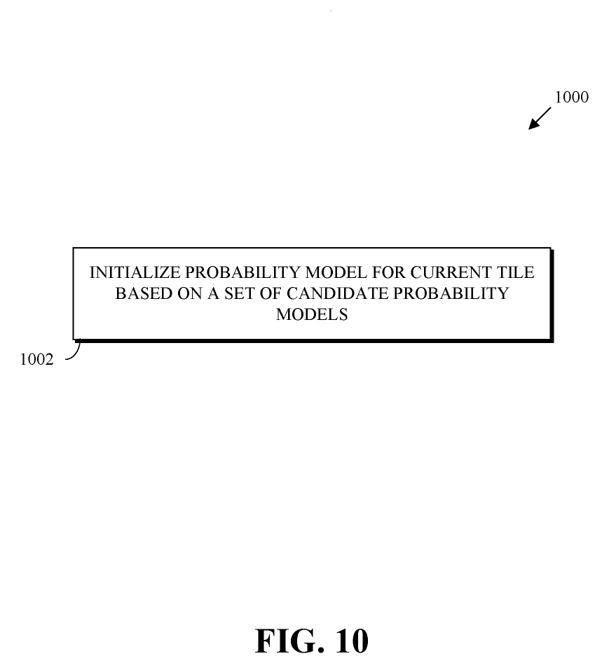

FIG. 10 is a flowchart describing a second technique 1000 for probability model initialization for a tile based on candidate probability model selection. Technique 1000 may be performed by an encoder or decoder, such as encoder 400 using entropy encoding stage 408 or decoder 500 using entropy decoding stage 502.

Step 1002 includes initializing a probability model for a current tile in a current frame based on a set of candidate probability models selected from probability models determined for respective tiles in a reference frame and saved to a reference frame buffer. For example, in some implementations, step 1002 may operate according to or using technique 900, steps of technique 900, or modifications thereof.

In some implementations, technique 1000 includes decoding a first identification of probability models determined for respective tiles in the reference frame that are selected for the set of candidate probability models. For example, an encoder may determine which tiles to obtain probability models from for the set of candidate probability models and a tile index for one or more of those tiles may be included in a compressed bitstream and decoded as the first identification.

In some implementations, technique 1000 includes decoding a second identification of a candidate probability model of the set of candidate probability models to be utilized to initialize the probability model for the current tile. For example, an encoder may determine which of the candidate probability models to use to initialize the probability model for the current tile and may include in the compressed bitstream an index identifying the candidate probability model to be used for the current tile.

In such an implementation, initializing the probability model for the current tile includes initializing the probability model for the current tile using the candidate probability model identified by the second identification. The set of candidate probability models may include a number of probability models equal to the minimum of a maximum limit and a number of tiles in the reference frame. The first identification of probability models may include a syntax element for each candidate probability model of the set of candidate probability models that identifies a tile index identifying a tile from which such candidate probability model is to be selected from. For example, an encoder may determine which tiles are used to obtain the candidate probability models and the first identification may include the index for each of those tiles. The syntax element for each candidate probability model may be signaled using a number of bits equal to a ceiling of log2 of the number of tiles in the reference frame.

In some implementations, technique 1000 includes decoding a third identification of the reference frame and selecting one of the set of candidate probability models based on the third identification. In such an implementation, the set of candidate probability models are associated with the reference frame in the reference frame buffer. For example, the third identification and the second identification may be used to obtain the correct candidate probability model for the current tile.

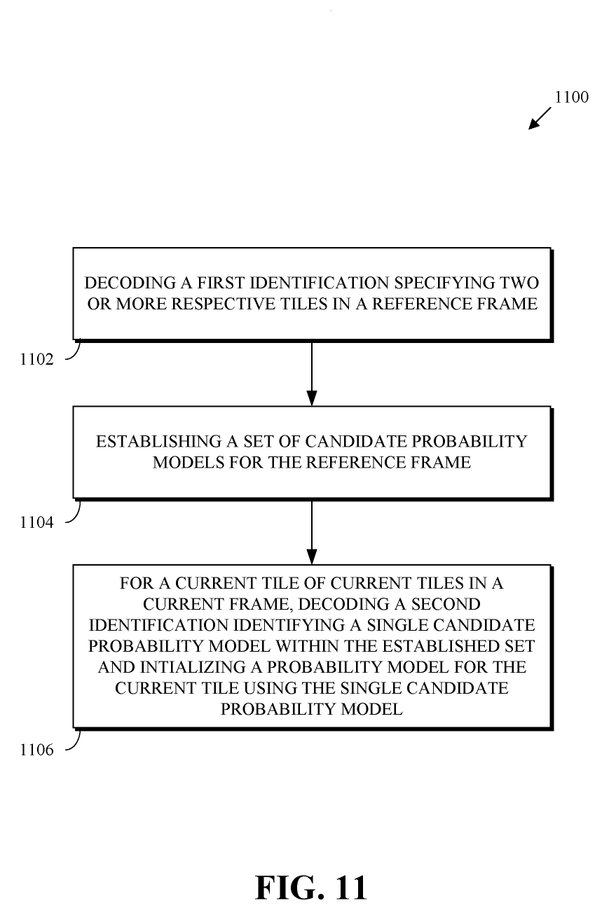

FIG. 11 is a flowchart describing a third technique 1100 for probability model initialization for a tile based on candidate probability model selection. Technique 1100 may be performed by an encoder or decoder, such as encoder 400 using entropy encoding stage 408 or decoder 500 using entropy decoding stage 502, and can be executed using computing devices, such as the systems, hardware, and software described above.

At step 1102, technique 1100 includes decoding a first identification from a bitstream, the first identification specifying two or more respective tiles in a reference frame. For example, a decoder 500 may parse the bitstream 420 to obtain the first identification, which indicates the source tiles from which probability models will be drawn to form a candidate set. For example, step 1102 may be performed in connection with steps 612 and/or 616 of FIG. 6 or technique 850 of FIG. 8.

In some implementations, the first identification includes a syntax element for each candidate probability model, where the syntax element identifies a tile index of a tile in the reference frame from which a respective candidate probability model is obtained. The syntax element may be signaled using a number of bits equal to a ceiling of log2 of a number of tiles in the reference frame. In other implementations, the two or more respective tiles in the reference frame are selected based on a predetermined coding order, such as by comprising a first N tiles to be encoded or decoded in the reference frame, where N is an integer greater than one.

At step 1104, technique 1100 includes establishing a set of candidate probability models for the reference frame in a reference frame buffer by populating the set with probability models obtained from the two or more respective tiles specified by the first identification. This may be implemented consistent with the architecture of FIG. 8, where the established set of candidate probability models corresponds to the PM[] array (e.g., 814, 816) stored in a storage area (e.g., 810) of the reference frame buffer (RFB) 802. If implemented consistent with technique 600 described with respect to FIG. 6, step 1104 may be performed in connection with steps 612, 614, and/or 616.

In some implementations, the set of candidate probability models includes a number of probability models equal to a minimum of a maximum limit and a number of tiles in the reference frame.

In some implementations, establishing the set of candidate probability models is a dynamic process. Examples of such a dynamic process for establishing the set are described above including with respect to step 612 of FIG. 6. For example, for a subsequent tile in the reference frame processed after the set includes a maximum number of candidate probability models, a size of the subsequent tile may be compared to a size of a source tile corresponding to a probability model currently in the set. Responsive to the size of the subsequent tile being larger than the size of the source tile, the probability model from the source tile may be replaced with a probability model from the subsequent tile in the set. In other implementations, tiles may be cached based on a distribution of locations within the reference frame or based on the tiles having a largest number of counts associated with their probability models.

In some implementations, establishing the set of candidate probability models may be performed using the two-tiered storage configuration of FIG. 7. This includes caching a plurality of intermediate probability models from a plurality of tiles of the reference frame in a first storage area (e.g., first storage 702 implemented as SRAM) and subsequently saving a subset of the plurality of intermediate probability models from the first storage area to the reference frame buffer, the reference frame buffer being located in a second storage area (e.g., second storage 800 implemented as DRAM).

In some implementations, the models populated into the set may include combined probability models. For example, establishing a set of candidate probability models for the reference frame in a reference frame buffer may include populating the set with at least one combined probability model generated based on probability models for two or more tiles in the reference frame. For example, probability models from the set of candidate probability models or from other probability models corresponding to tiles in the reference frame may be combined, such as through an average or weighted average. For example, the set of candidate probability models may include a combined probability model based on probability models from a sampling of locations in the reference frame, a combined probability model based on probability models from the reference frame having a minimum number of counts, a combined probability model from probability models of tiles having a certain minimum size, one or more probability models from tiles of the reference frame that are not combined, or combinations thereof.

At step 1106, technique 1100 includes, for a current tile of a plurality of current tiles in a current frame, decoding a second identification from the bitstream and initializing a probability model for the current tile. The second identification identifies a single candidate probability model within the established set, and the initialization uses the single candidate probability model pointed to by the second identification. This step may be implemented in connection with an implementation of FIG. 9, where the second identification corresponds to the model selection information (MSI) 930, which is used to select a single probability model (e.g., 914 or 916) from the candidate probability model array.

In some implementations, the second identification includes an index corresponding to one of the set of candidate probability models stored in the reference frame buffer.

Technique 1100 may further include decoding a third identification (i.e. a reference frame identification) from the bitstream. In such cases, the set of candidate probability models for the reference frame is selected from sets of candidate probability models for a plurality of reference frames stored in the reference frame buffer based on the third identification. This step may be implemented in connection with an implementation of FIG. 9, using the reference frame selection information (RFS) 920 of FIG. 9 to select a particular storage area (e.g., 912) within the RFB 910 that contains the appropriate set of candidate models.

In some implementations, the current tile is a first current tile and the single candidate probability model is a first single candidate probability model. In such an implementation, technique 1100 further includes, for a second current tile of the plurality of current tiles, decoding a fourth identification identifying a second single candidate probability model within the established set, and initializing a probability model for the second current tile using the second single candidate probability model. The initializing for the first current tile and the initializing for the second current tile may be performed in a non-blocking manner to facilitate parallel processing.

For simplicity of explanation, the foregoing techniques are depicted and described as a series of steps or operations. However, the steps or operations in accordance with this disclosure can occur in various orders and/or concurrently. Additionally, other steps or operations not presented and described herein may be used. Furthermore, not all illustrated steps or operations may be required to implement a method in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server and the receiving station 106 can be implemented on a device separate from the server, such as a hand-held communications device. In this instance, the transmitting station 102 can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device and/or a device including an encoder 400 may also include a decoder 500.

Further, all or a portion of implementations of the present disclosure can take the form of a computer program product accessible from, for example, a non-transitory computer-usable or computer-readable medium. A computer-usable or computer-readable medium can be any device that can, for example, tangibly contain, store, communicate, or transport a program including instructions for use by or in connection with any processor. For example, a processor may be configured to perform executed instructions stored in the memory (e.g., computer readable medium) to perform techniques embodied in the instructions. For example, a non-transitory computer-readable storage medium may include executable instructions that, when executed by a processor, facilitate performance of operations corresponding to techniques described in this disclosure. For example, a non-transitory computer-readable storage medium may store an encoded bitstream that is encodable or decodable using techniques described in this disclosure. The medium can be, for example, an electronic, magnetic, optical, electromagnetic, or semiconductor device. Other suitable mediums are also available.

The above-described embodiments, implementations and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method for initializing probability models for tiles of a current frame in a video stream, the method comprising:
decoding a first identification from a bitstream, the first identification specifying two or more respective tiles in a reference frame;
establishing a set of candidate probability models for the reference frame in a reference frame buffer by populating the set with probability models obtained from the two or more respective tiles specified by the first identification; and
for a current tile of a plurality of current tiles in a current frame:
decoding a second identification from the bitstream, the second identification identifying a single candidate probability model within the established set, and
initializing a probability model for the current tile using the single candidate probability model pointed to by the second identification.

2. The method of claim 1, wherein the first identification includes a syntax element for each candidate probability model in the set of candidate probability models, the syntax element identifying a tile index of a tile in the reference frame from which a respective candidate probability model in the set of candidate probability models is obtained.

3. The method of claim 2, wherein the syntax element for each candidate probability model is signaled using a number of bits equal to a ceiling of log2 of a number of tiles in the reference frame.

4. The method of claim 1, further comprising decoding a third identification from the bitstream, wherein the set of candidate probability models for the reference frame is selected from sets of candidate probability models for a plurality of reference frames stored in the reference frame buffer based on the third identification.

5. The method of claim 1, wherein the second identification includes an index corresponding to one of the set of candidate probability models.

6. The method of claim 1, wherein the set of candidate probability models includes a number of probability models equal to a minimum of a maximum limit and a number of tiles in the reference frame.

7. The method of claim 1, wherein the set of candidate probability models are associated with the reference frame in the reference frame buffer, wherein the method further comprises:
decoding a third identification of the reference frame; and
selecting the set of candidate probability models based on the third identification.

8. The method of claim 1, wherein the two or more respective tiles in the reference frame are selected based on a predetermined coding order, the two or more respective tiles comprising a first N tiles to be encoded or decoded in the reference frame, where N is an integer greater than one.

9. The method of claim 1, wherein establishing the set of candidate probability models comprises:
for a subsequent tile in the reference frame processed after the set of candidate probability models includes a maximum number of candidate probability models, comparing a size of the subsequent tile to a size of a source tile corresponding to a probability model currently in the set of candidate probability models; and
responsive to the size of the subsequent tile being larger than the size of the source tile, replacing the probability model from the source tile with a probability model from the subsequent tile in the set of candidate probability models.

10. The method of claim 1, wherein establishing the set of candidate probability models comprises:
caching a plurality of intermediate probability models from a plurality of tiles of the reference frame in a first storage area; and
subsequently saving a subset of the plurality of intermediate probability models from the first storage area to the reference frame buffer, the reference frame buffer being located in a second storage area.

11. The method of claim 1, wherein the current tile is a first current tile and the single candidate probability model is a first single candidate probability model, the method further comprising:
for a second current tile of the plurality of current tiles in the current frame:
decoding a fourth identification from the bitstream, the fourth identification identifying a second single candidate probability model within the established set of candidate probability models, and
initializing a probability model for the second current tile using the second single candidate probability model pointed to by the fourth identification,
wherein initializing the probability model for the first current tile and initializing the probability model for the second current tile are performed in a non-blocking manner.

12. The method of claim 1, wherein establishing a set of candidate probability models for the reference frame in a reference frame buffer further includes populating the set with at least one combined probability model generated based on probability models for two or more tiles in the reference frame.

13. A device for initializing probability models for tiles of a current frame in a video stream, the device comprising:
a memory; and
a processor configured to execute instructions stored in the memory to:
decode a first identification from a bitstream, the first identification specifying two or more respective tiles in a reference frame;
establish a set of candidate probability models for the reference frame in a reference frame buffer by populating the set with probability models obtained from the two or more respective tiles specified by the first identification; and
for a current tile of a plurality of current tiles in a current frame:
decode a second identification from the bitstream, the second identification identifying a single candidate probability model within the established set, and
initialize a probability model for the current tile using the single candidate probability model pointed to by the second identification.

14. The device of claim 13, wherein the first identification includes a syntax element for each candidate probability model in the set of candidate probability models, the syntax element identifying a tile index of a tile in the reference frame from which a respective candidate probability model in the set of candidate probability models is obtained.

15. The device of claim 13, wherein the processor is configured to execute instructions to establish the set of candidate probability models by:
for a subsequent tile in the reference frame processed after the set of candidate probability models includes a maximum number of candidate probability models, comparing a size of the subsequent tile to a size of a source tile corresponding to a probability model currently in the set of candidate probability models; and
responsive to the size of the subsequent tile being larger than the size of the source tile, replacing the probability model from the source tile with a probability model from the subsequent tile in the set of candidate probability models.

16. The device of claim 13, wherein the processor is configured to execute instructions to establish the set of candidate probability models by:
caching a plurality of intermediate probability models from a plurality of tiles of the reference frame in a first storage area; and
subsequently saving a subset of the plurality of intermediate probability models from the first storage area to the reference frame buffer, the reference frame buffer being located in a second storage area.

17. The device of claim 13, wherein the current tile is a first current tile, the single candidate probability model is a first single candidate probability model, and the processor is configured to execute instructions to:
for a second current tile of the plurality of current tiles in the current frame:
decode a fourth identification from the bitstream, the fourth identification identifying a second single candidate probability model within the established set of candidate probability models, and
initialize a probability model for the second current tile using the second single candidate probability model pointed to by the fourth identification,
wherein initializing the probability model for the first current tile and initializing the probability model for the second current tile are performed in a non-blocking manner.

18. A non-transitory computer-readable storage medium having stored thereon an encoded video bitstream including a first indication and a second indication, wherein the encoded video bitstream is decodable by a decoder configured to:
decode a first identification from the encoded video bitstream, the first identification specifying two or more respective tiles in a reference frame;
establish a set of candidate probability models for the reference frame in a reference frame buffer by populating the set with probability models obtained from the two or more respective tiles specified by the first identification; and
for a current tile of a plurality of current tiles in a current frame:
decode a second identification from the encoded video bitstream, the second identification identifying a single candidate probability model within the established set, and
initialize a probability model for the current tile using the single candidate probability model pointed to by the second identification.

19. The non-transitory computer-readable storage medium of claim 18, wherein the encoded video bitstream further includes a third identification and is decodable by a decoder configured to decode the third identification from the encoded video bitstream, wherein the set of candidate probability models for the reference frame is selected from sets of candidate probability models for a plurality of reference frames stored in the reference frame buffer based on the third identification.

20. The non-transitory computer-readable storage medium of claim 18, wherein the two or more respective tiles in the reference frame are selected based on a predetermined coding order, the two or more respective tiles comprising a first N tiles to be encoded or decoded in the reference frame, where N is an integer greater than one.
